(19) United States
(12) Patent Application Publication
(10) Pub. No.: US 2014/0373341 A1
(43) Pub. Date: Dec. 25, 2014

(54) METHOD FOR MANUFACTURING LAMINATED COIL COMPONENTS

(71) Applicant: MURATA MANUFACTURING CO., LTD., Kyoto (JP)

(72) Inventors: Kouji YAMAUCHI, Nagaokakyo-shi (JP); Mitsuru ODAHARA, Nagaokakyo-shi (JP)

(73) Assignee: MURATA MANUFACTURING CO., LTD., Kyoto (JP)

(21) Appl. No.: 14/295,465

(22) Filed: Jun. 4, 2014

(30) Foreign Application Priority Data
Jun. 21, 2013 (JP) 2013-130222

(51) Int. Cl. H01F 41/04

(52) U.S. Cl. CPC H01F 41/041
USPC 29/609

(57) ABSTRACT

A method for manufacturing a laminated coil component having: a step of placing a first green sheet having pairs of bordering first and second areas; a step of placing a second green sheet having pairs of bordering third and fourth areas; and a step of staggering another second green sheet on the second green sheet. The first, second, third and fourth areas have identical rectangular shapes and have a first, second, third and fourth conductor, respectively. The third and fourth linear conductors form a loop. An end of the first linear conductor is connected to a first side of the first area. A part of the first linear conductor closest to a second side adjacent to the first side has a line width smaller than a part of the third linear conductor or a part of the fourth linear conductor overlapping with the part of the first linear conductor.

### CROSS REFERENCE TO RELATED APPLICATIONS

This application claims benefit of priority to Japanese Patent Application No. 2013-130222 filed Jun. 21, 2013, the entire content of which is incorporated herein by reference.

### TECHNICAL FIELD

The present disclosure relates to a method for manufacturing laminated coil components, and more particularly to a method for manufacturing laminated coil components comprising a step of laminating green sheets, each having a plurality of linear conductors printed thereon, such that the green sheets are staggered in a direction perpendicular to the direction of lamination.

### BACKGROUND

As a conventional method for manufacturing laminated coil components, for example, a method for manufacturing electronic devices disclosed by Japanese Patent Laid-Open Publication No. 2010-3957 is known. According to the manufacturing method as disclosed by Japanese Patent Laid-Open Publication No. 2010-3957, as shown by FIG. 8, green sheets, each having a plurality of linear conductors printed thereon, are laminated while being staggered in a direction perpendicular to the direction of lamination to manufacture laminated coil components. Such a method where green sheets are laminated in a staggered manner is referred to as staggering lamination.

Specifically, according to the conventional method for manufacturing laminated coil components, the green sheets have identical printed patterns 500. The printed pattern 500 comprises areas A501, each having a linear conductor 501, and areas A502, each having a linear conductor 502. The areas A501 and the areas A502 are arranged alternately. By placing the areas A501 and A502 on each other in the direction of lamination to connect the linear conductors 501 and 502, it is possible to produce a coil making a full circle. According to the conventional method for manufacturing laminated coil components, therefore, by placing each green sheet on the previously placed green sheet with a shift of one area in a direction perpendicular to the direction of lamination, it is possible to produce a coil that makes a full circle in two adjacent green sheets. In the conventional method for manufacturing laminated coil components, further, by placing a topmost green sheet and a lowermost green sheet with a shift of a half area in the direction perpendicular to the direction of lamination, the linear conductors in the laminated coil component can be connected to an external electrode. Thus, according to the conventional method for manufacturing laminated coil components, the printed patterns formed on all of the green sheets are identical. The printed patterns 500 on the green sheets are formed by using a same printing mask.

Formation of identical printed patterns on all of the green sheets limits the flexibility in design of laminated coil components. Therefore, a new method for manufacturing laminated coil components as shown by FIG. 9 was suggested. In the new method, the green sheets M600 and M700 have printed patterns 600 and 700 including linear conductors to be connected to external electrodes respectively, and the green sheets M500 have the printed patterns 500 including the linear conductors 501 and 502 to be made into coils. The printed patterns 600 and 700 are different from the printed pattern 500.

In the new method, different print masks are needed for printing of the pattern 500 and for printing of the pattern 600. Therefore, as shown by FIGS. 10A and 10B, the positions of the linear conductors on the green sheet M500 relative to a reference point RP, which is used as a reference in laminating the green sheets, may be different from the positions of the linear conductors on the green sheet M600 relative to the reference point RP. (This is hereinafter referred to as a print misalignment error.) Also between the green sheet M500 and the green sheet M700, such a print misalignment error may occur.

In this case, when the green sheets M500, M600 and M700 are laminated, as shown by FIG. 11, the linear conductors 601 and 701 on the green sheets M600 and M700 may protrude in a direction perpendicular to the direction of lamination from the linear conductors 501 on the green sheets M500. Since the patterns 500 are printed by use of a same mask, the positions of the linear conductors printed on the respective green sheets M500 are the same relative to the reference point RP, and when these green sheets M500 are laminated, there is no linear conductor protruding from the other linear conductors. However, the patterns 600 and 700 are printed by use of different masks from the mask used for printing of the patterns 500. Therefore, the positions of the linear conductors relative to the reference point RP vary depending on the mask used for formation of the linear conductors. Consequently, after lamination of the green sheets, some of the linear conductors are misaligned and protrude from the other linear conductors. Generally, the degree of misalignment of linear conductors after lamination of green sheets due to print misalignment errors caused by the use of different masks is greater than the degree of misalignment of linear conductors caused by staggering lamination.

### SUMMARY

An object of the present disclosure is to provide a method for manufacturing laminated coil components using staggering lamination, which does not cause misalignment of linear conductors after lamination of green sheets due to a print misalignment error.

An embodiment relates to a method for manufacturing a laminated coil component by laminating green sheets, each having a plurality of printed linear conductors thereon, and the method comprises: a step of placing a first green sheet comprising pairs of a first area and a second area having rectangular identical shapes and bordering each other, the first area having a first linear conductor printed thereon, the second area having a second linear conductor printed thereon; a step of placing a second green sheet, comprising pairs of a third area and a fourth area having identical shapes with the first area and bordering each other, the third area having a third linear conductor printed thereon, the fourth area having a fourth linear conductor printed thereon; and a step of staggering another second green sheet on the second green sheet in a direction perpendicular to a direction of lamination by an amount corresponding to a side of the rectangular first area. The third linear conductor and the fourth linear conductor form a loop when viewed from the direction of lamination. An end of the first linear conductor is connected to a first side being an edge of the first area. A part of the first linear conductor closest to a second side adjacent to the first side has a line width smaller than a part of the third linear conductor overlapping with the part of the first linear conductor when viewed from the direction of lamination or than a part of the fourth linear conductor overlapping with the part of the first linear conductor when viewed from the direction of lamination.

### BRIEF DESCRIPTION OF THE DRAWINGS

FIG. 1 is a perspective view showing the appearance of a laminated coil component produced by a manufacturing method according to an embodiment.

FIG. 2 is an exploded perspective of the laminated coil component produced by the manufacturing method according to the embodiment.

FIG. 3 is an exploded perspective view showing green sheets used in the manufacturing method according to the embodiment.

FIGS. 4A and 4B are sectional views taken along the line 4-4 in FIG. 1.

FIG. 5 is an exploded perspective view of a laminated coil component produced by a manufacturing method according to a first modification.

FIG. 6 is an exploded perspective view of a laminated coil component produced by a manufacturing method according to a second modification.

FIG. 7 is an exploded perspective view of a laminated coil component produced by a manufacturing method according to a third modification.

FIG. 8 is an exploded perspective view showing green sheets used in a method for manufacturing laminated coil components in the same kind as the manufacturing method disclosed by Japanese Patent Laid-Open Publication No. 2010-3957.

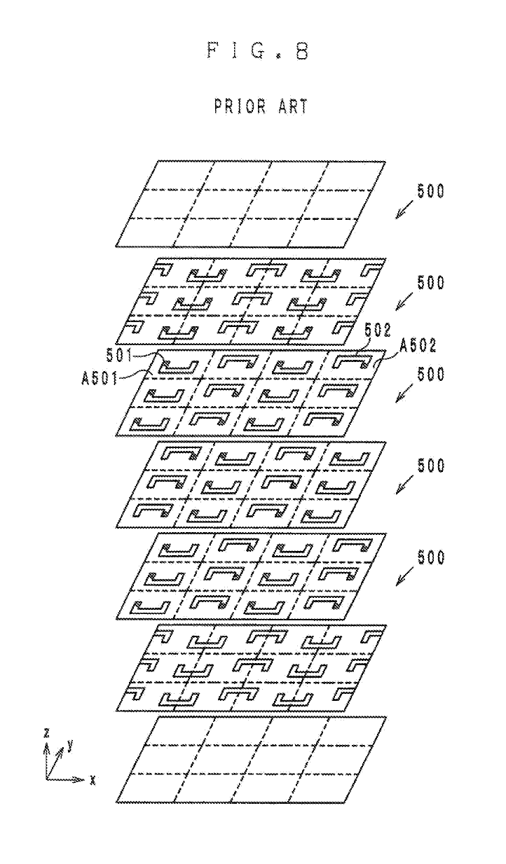

FIG. 9 is an exploded perspective view showing green sheets used in a new method for manufacturing laminated coil components.

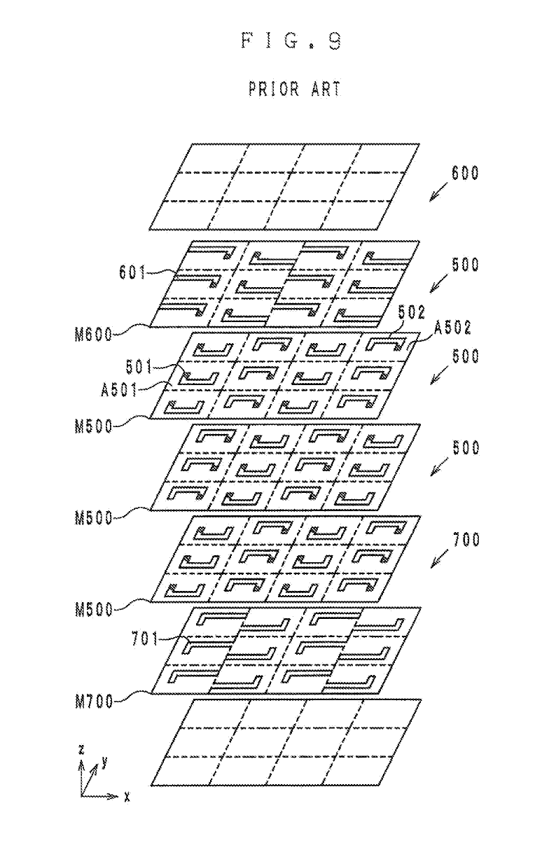

FIGS. 10A and 10B are plan views of green sheets used in the new method for manufacturing laminated coil components.

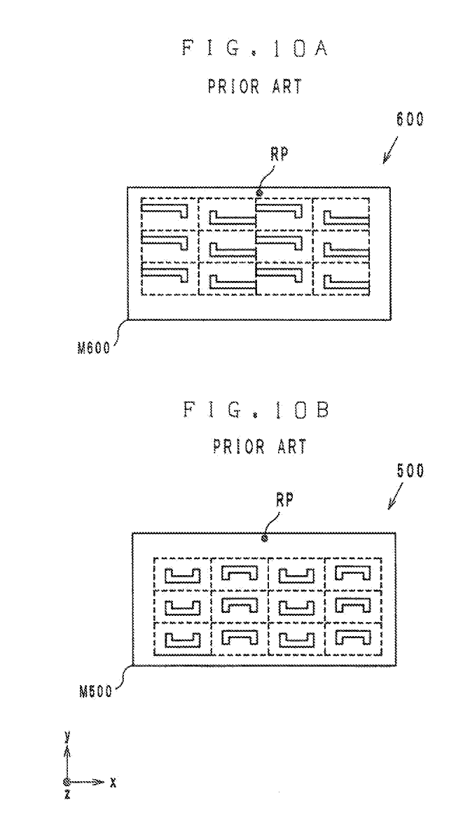

FIG. 11 is a sectional view of a laminated coil produced by the new method for manufacturing laminated coil components.

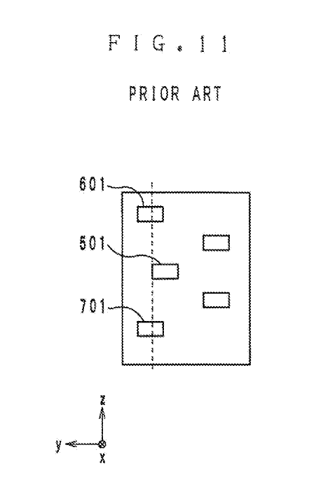

### DETAILED DESCRIPTION

A laminated coil component produced by a manufacturing method according to an embodiment, and the manufacturing method are hereinafter described.

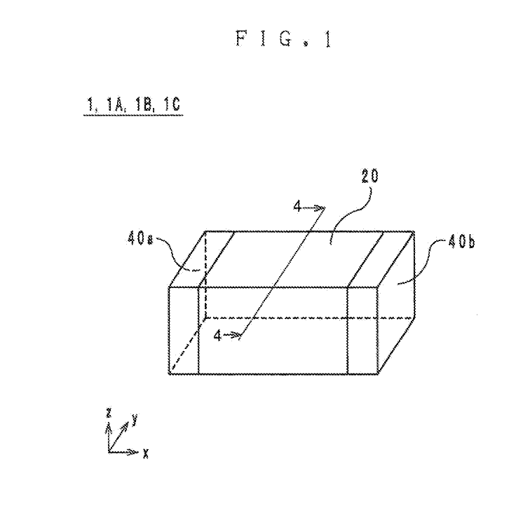

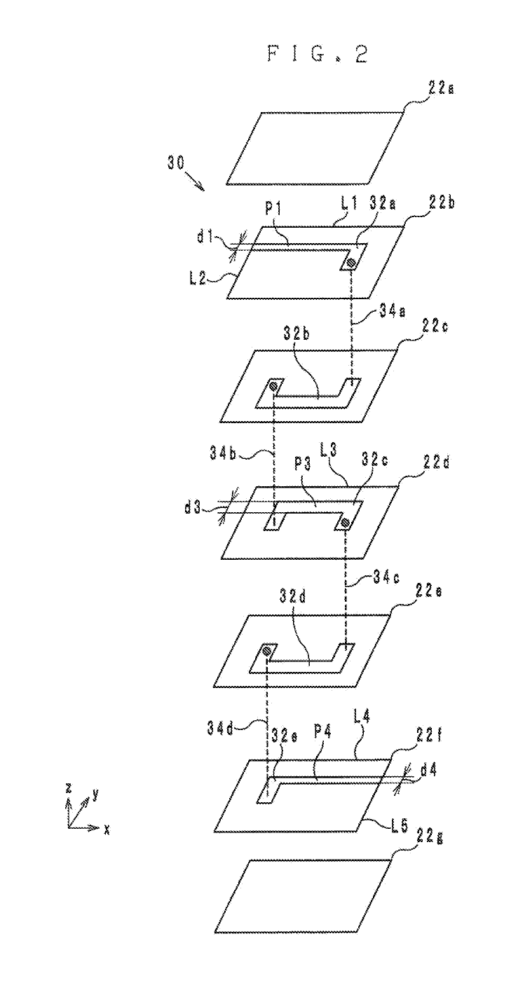

### Structure of Laminated Coil Component; See FIGS. 1 and 2

The structure of a laminated coil component 1 produced by a manufacturing method according to an embodiment is described with reference to the drawings. Here, a direction of lamination of the laminated coil component 1 is defined as a z-axis direction. A direction along the longer sides of the laminated coil component 1 when viewed from the z-axis direction is defined as an x-axis direction, and a direction along the shorter sides of the laminated coil component 1 when viewed from the z-axis direction is defined as a y-axis direction. The x-axis direction, the y-axis direction and the z-axis direction are perpendicular to each other.

The laminated coil component 1 comprises a laminate body 20, a coil 30 and external electrodes 40a and 40b. The laminated coil component 1 is in the shape of a rectangular parallelepiped as shown by FIG. 1.

The laminate body 20, as shown by FIG. 2, comprises insulating layers 22a through 22g placed one upon another in this order from a positive side in the z-axis direction. The insulating layers 22a through 22g are rectangular when viewed from the z-axis direction. Accordingly, the laminate body 20 structured by placing the insulating layers 22a through 22g one upon another is in the shape of a rectangular parallelepiped as shown by FIG. 1. In the following paragraphs, a positive side in the z-axis direction of each of the insulating layers 22a through 22g is referred to as an upper surface, and a negative side in the z-axis direction of each of the insulating layers 22a through 22g is referred to as a lower surface. As the material for the insulating layers 22a through 22g, a magnetic material (for example, ferrite or the like) or a non-magnetic material (for example, glass, alumina or the like, or a complex thereof) can be used.

As shown in FIG. 1, the external electrode 40a is provided to cover a surface at a negative side in the x-axis direction and parts of its surrounding surfaces of the laminate body 20. The external electrode 40b is provided to cover a surface at a positive side in the x-axis direction and parts of its surrounding surfaces of the laminate body 20. As the material for the external electrodes 40a and 40b, a conductive material, such as Au, Ag, Pd, Cu, Ni or the like, can be used.

As shown by FIG. 2, the coil 30 is located inside the laminate body 20, and comprises linear conductors 32a through 32e and via conductors 34a through 34d. The coil 30 is spiral, and the spiral coil 30 has a central axis parallel to the z-axis. Accordingly, the coil 30 spirals as progressing in the direction of lamination. As the material for the coil 30, a conductive material, such as Au, Ag, Pd, Cu, Ni or the like, can be used.

The linear conductor 32a is provided on the upper surface of the insulating layer 22b. The linear conductor 32a extends along an edge at a positive side in the x-axis direction and along an edge L1 at a positive side in the y-axis direction of the insulating layer 22b. Accordingly, the linear conductor 32a is L-shaped when viewed from the z-axis direction. An end of the linear conductor 32a at a negative side in the x-axis direction is connected to an edge L2 at the negative side in the x-axis direction of the insulating layer 22b, and the end of the linear conductor 32a is exposed on the surface of the laminate body 20, at the edge L2. Thereby, the linear conductor 32a is connected to the external electrode 40a. The other end of the linear conductor 32a at the positive side in the x-axis direction is connected to the via conductor 34a pierced in the insulating layer 22b in the z-axis direction.

The linear conductor 32b is provided on the upper surface of the insulating layer 22c. The linear conductor 32b extends along edges at the positive and negative sides in the x-axis direction and along an edge at a negative side in the y-axis direction of the insulating layer 22c. Accordingly, the linear conductor 32b is in the shape of a U with an open end at the positive side in the y-axis direction when viewed from the z-axis direction. An end of the linear conductor 32b at the positive side in the x-axis direction is connected to the via conductor 34a. The other end of the linear conductor 32b at the negative side in the x-axis direction is connected to the via conductor 34b pierced in the insulating layer 22c in the z-axis direction.

The linear conductor 32c is provided on the upper surface of the insulating layer 22d. The linear conductor 32c extends along edges at the positive and negative sides in the x-axis direction and along an edge L3 at the positive side in the y-axis direction of the insulating layer 22d. Accordingly, the linear conductor 32c is in the shape of a U with an open end at the negative side in the y-axis direction when viewed from the z-axis direction. Therefore, the linear conductor 32b, which is in the shape of a U with an open end at the positive side in the y-axis direction, and the linear conductor 32c form a loop when viewed from the z-axis direction. An end of the linear conductor 32c at the negative side in the x-axis direction is connected to the via conductor 34b. The other end of the linear conductor 32b at the positive side in the x-axis direction is connected to the via conductor 34c pierced in the insulating layer 22d in the z-axis direction.

The linear conductor 32d is provided on the upper surface of the insulating layer 22e. The linear conductor 32d extends along edges at the positive and negative sides in the x-axis direction and along an edge at the negative side in the y-axis direction of the insulating layer 22e. Accordingly, the linear conductor 32d is in the shape of a U with an open end at the positive side in the y-axis direction when viewed from the z-axis direction. Thus, the linear conductor 32d is in the same shape as the linear conductor 32b. Therefore, the linear conductor 32c, which is in the shape of a U with an open end at the negative side in the y-axis direction, and the linear conductor 32d form a loop when viewed from the z-axis direction. An end of the linear conductor 32d at the positive side in the x-axis direction is connected to the via conductor 34c. The other end of the linear conductor 32d at the negative side in the x-axis direction is connected to the via conductor 34d pierced in the insulating layer 22e in the z-axis direction.

The linear conductor 32e is provided on the upper surface of the insulating layer 22f. The linear conductor 32e extends along an edge at the negative side in the x-axis direction and along an edge L4 at the positive side in the y-axis direction of the insulating layer 22f, and is L-shaped when viewed from the z-axis direction. An end of the linear conductor 32e at the negative side in the x-axis direction is connected to the via conductor 34d. The other end of the linear conductor 32e at the positive side in the x-axis direction is connected to an edge L5 at the positive side in the x-axis direction of the insulating layer 22f. Therefore, the end of the linear conductor 32e at the positive side in the x-axis direction is exposed on the surface of the laminate body 20, at the edge L5, and is connected to the external electrode 40b.

In the laminated coil component 1 of the structure above, when viewed from the z-axis direction, a part P1 of the linear conductor 32a extending along the edge L1 overlaps with a part P3 of the linear conductor 32c extending along the edge L3. The line width d1 of the part P1 is smaller than the line width d3 of the part P3. When viewed from the z-axis direction, also, a part P4 of the linear conductor 32e extending along the edge L4 overlaps with the part P3 of the linear conductor 32c extending along the edge L3. The line width d4 of the part P4 is smaller than the line width d3 of the part P3.

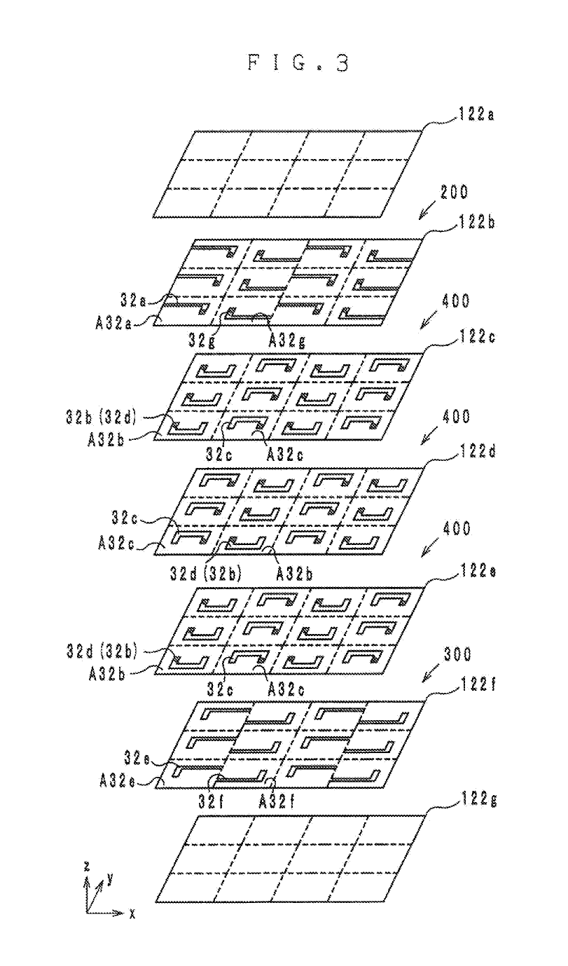

### Manufacturing Method; See FIG. 3

A method for manufacturing laminated coil components according to an embodiment is hereinafter described with reference to the drawings. In the following paragraphs, the z-axis direction means a direction in which green sheets are stacked. The x-axis direction and the y-axis direction mean a direction along the longer sides and a direction along the shorter sides, respectively, of laminated coil components 1 to be manufactured by the method according to the embodiment.

First, green sheets to be made into the insulating layers 22a through 22g are prepared. Specifically, Fe₂O₃, ZnO and NiO are prepared at a specified ratio by weight, and these materials are put in a ball mill and are wet-blended. The resultant mixture is dried and crushed into powder, and the powder is calcined. Further, the calcined powder is wet-milled in a ball mill, dried and crushed. In this way, ferrite ceramic powder is obtained.

A binder (vinyl acetate, water-soluble acrylic or the like), a plasticizer, a wetter and a dispersant are added to the ferrite ceramic powder, and these materials are mixed in a ball mill. Thereafter, defoaming by decompression is carried out. The resultant ceramic slurry is spread over a carrier film and made into a sheet by a doctor blade method, and the sheet is dried. In this way, green sheets 122a through 122g to be made into the insulating layers 22a through 22g are prepared.

Next, the green sheets 122b through 122e are irradiated with a laser beam, whereby via holes are made in the green sheets 122b through 122e. By filling the via holes with a conductive paste consisting mainly of Au, Ag, Pd, Cu, Ni or the like, the via conductors 34a through 34d are formed. The process of filling the via holes with the conductive paste may be carried out simultaneously with a process of forming the linear conductors 32a through 32e, which will be described later.

After the formation of via holes or the formation of via conductors, the conductive paste consisting mainly of Au, Ag, Pd, Cu, Ni or the like is applied to the respective upper surfaces of the green sheets 122b through 122f by screen printing such that the linear conductors 32a through 32e are formed.

In this process, as shown in FIG. 3, a pattern 200 is printed on the green sheet 122b. The printed pattern 200 comprises linear conductors 32a and linear conductors 32g. The linear conductors 32g have rotational symmetries with the linear conductors 32a through 180 degrees on a plane parallel to the x-axis and the y-axis. The green sheet 122b with the printed pattern 200 is divided into areas A32a, each having a printed linear conductor 32a, and areas A32g, each having a printed linear conductor 32g. The areas A32a and A32g are arranged alternately in the x-axis direction, and pairs of bordering areas A32a and A32g are arranged in a grid-like pattern. The areas A32a and A32g are rectangular and identical in shape.

A pattern 300 is printed on the green sheet 122f. The printed pattern 300 comprises linear conductors 32e and linear conductors 32f. The linear conductors 32f have rotational symmetries with the linear conductors 32e through 180 degrees on a plane parallel to the x-axis and the y-axis. The green sheet 122f with the printed pattern 300 is divided into areas A32e, each having a printed linear conductor 32e, and areas A32f, each having a printed linear conductor 32f. The areas A32e and A32f are arranged alternately in the x-axis direction, and pairs of bordering areas A32e and A32f are arranged in a grid-like pattern. The areas A32e and A32f are rectangular and identical in shape. Also, the areas 32e and 32f are identical with the areas A32a in shape.

A pattern 400 is printed on the green sheets 122c through 122e by use of the same mask. The printed pattern 400 comprises linear conductors 32b through 32d. Each of the green sheets 122c through 122e with the printed pattern 400 is divided into areas A32b, each having a printed linear conductor 32b (32d) and areas A32c, each having a printed linear conductor 32c. The areas A32b and A32c are arranged alternately in the x-axis direction, and pairs of bordering areas A32b and A32c are arranged in a grid-like pattern. The areas A32b and A32c are rectangular and are identical with the areas A32e in shape.

Next, the green sheets 122a through 122g are laminated in this order and press-bonded together, whereby an unfired mother laminate is obtained.

Specifically, first, the green sheet 122g is placed on a retainer plate such as an alumina substrate (not shown) or the like.

Next, the green sheet 122f is placed on the green sheet 122f.

Further, the green sheet 122e is placed on the green sheet 122f. Thereby, the linear conductors 32d (32b) on the green sheet 122e are located over the linear conductors 32e via the green sheet 122e. At the same time, the linear conductors 32c on the green sheet 122e are located over the linear conductors 32f via the green sheet 122e.

Next, the green sheet 122d is placed on the green sheet 122e. At this time, the green sheet 122d is staggered from the green sheet 122e to the positive side in the x-axis direction by one area. Thereby, the linear conductors 32c on the green sheet 122d are located over the linear conductors 32d (32b) via the green sheet 122d. At the same time, the linear conductors 32d (32b) on the green sheet 122d are located over the linear conductors 32c via the green sheet 122d.

Next, the green sheet 122c is placed on the green sheet 122d. At this time, the green sheet 122c is staggered from the green sheet 122d to the negative side in the x-axis direction by one area. Thereby, the linear conductors 32b (32d) on the green sheet 122c are located over the linear conductors 32c via the green sheet 122c. At the same time, the linear conductors 32c on the green sheet 122d are located over the linear conductors 32b (32d) via the green sheet 122d.

Next, the green sheet 122b is placed on the green sheet 122c. Thereby, the linear conductors 32a on the green sheet 122b are located over the linear conductors 32b (32d) via the green sheet 122b. At the same time, the linear conductors 32g on the green sheet 122b are located over the linear conductors 32c via the green sheet 122b.

Further, the green sheet 122a is placed on the green sheet 122b.

After completion of the laminating process, the unfired mother laminate is pressed, for example, by isotonic press to be securely press-bonded.

Next, the mother laminate is cut by a cutting blade into laminate bodies 20 of a specified size. Thereafter, the unfired laminate bodies 20 are debindered and fired. The debinding process is carried out, for example, in a hypoxic atmosphere at a temperature of 500 degrees C. for two hours. The firing process is carried out, for example, at a temperature of 800 to 900 degrees C. for two hours and a half.

After the firing process, the external electrodes 40a and 40b are formed on the laminate bodies 20. First, electrode paste made of a conductive material consisting mainly of Ag is applied on the surfaces of the laminate bodies 20. Next, the electrode paste applied on the laminate bodies 20 is baked at a temperature of 800 degrees C. for one hour. In this way, underlayer electrodes of the external electrodes 40a and 40b are formed.

Finally, the underlayer electrodes are plated with Ni/Sn. Thereby, the external electrodes 40a and 40b are formed. With this process, the laminated coil components 1 are completely produced.

In the above-described method for manufacturing laminated coil components, not only the laminated coil components 1 but also laminated coil components each comprising the linear conductors 32b through 32d, 32f and 32g are produced. The laminated coil components each comprising the linear conductors 32b through 32d, 32f and 32g are different from the laminated coil components 1 only in the relation of connection between the coils inside the respective laminate bodies and the external electrodes 40a and 40b. There are no other great differences between the laminated coil components 1 and the laminated coil components each comprising the linear conductors 32b through 32d, 32f and 32g, and a detailed description of the latter laminated coil components is not given. Each of the laminated coil components comprising the linear conductors 32b through 32d, 32f and 32g becomes a laminated coil component of the same structure as the laminated coil component 1 when turned around the Z-axis by 180 degrees.

### Advantageous Effects; See FIGS. 2 through 4

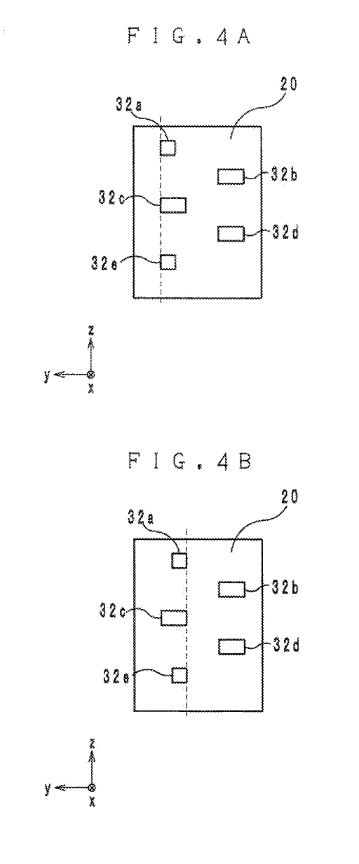

In each of the laminated coil components 1 produced by the manufacturing method according to the embodiment above, as shown by FIG. 2, the line widths d1 and d4 of the parts P1 and P4 of the linear conductors 32a and 32e extending along the edges L1 and L4 respectively are smaller than the line width d3 of the part P3 of the linear conductor 32c extending along the edge L3. With this arrangement, even if the linear conductors 32a and 32e are misaligned from the linear conductors 32c due to print displacement, the linear conductors 32a and 32e are, as shown by FIGS. 4A and 4B, prevented from protruding from the linear conductors 32c in a direction perpendicular to the direction of lamination (more particularly, in the positive y-axis direction). As a result, when the mother laminate is cut with reference to the positions of the linear conductors 32c, it does not happen that the linear conductors 32a and 32e are exposed on the surfaces of the respective laminated coil components 1. Further, even if the linear conductors 32a and 32e are misaligned from the linear conductors 32c in the negative y-axis direction, it does not happen that the linear conductors 32a and 32e protrude into the insides of the spirals of the respective coils, and therefore, a reduction in inductance can be prevented. Thus, the laminated coil components produced by the manufacturing method according to the embodiment above are nearly unaffected by misalignment of linear conductors after lamination due to print displacement.

In the method for manufacturing laminated coil components according to the embodiment above, as shown by FIG. 3, the green sheet 122c is placed on the green sheet 122d while being staggered from the green sheet 122d by one area in the x-axis direction. In other words, in the manufacturing method according to the embodiment above, staggering lamination in the y-axis direction is not carried out. Therefore, it is less likely that the linear conductors 32b are misaligned from the linear conductors 32c in the y-axis direction. As a result, when the mother laminate is cut with reference to the positions of the linear conductors 32c, the linear conductors 32b are prevented from being exposed to the surfaces of the respective laminated coil components 1. Further, since the linear conductors 32b are prevented from protruding into the inside of the spirals of the respective coils, it is less likely that the inductance value decreases. Also, the green sheet 122d is placed on the green sheet 122e while being staggered from the green sheet 122e by one area in the x-axis direction. This arrangement also brings the same effect as described above.

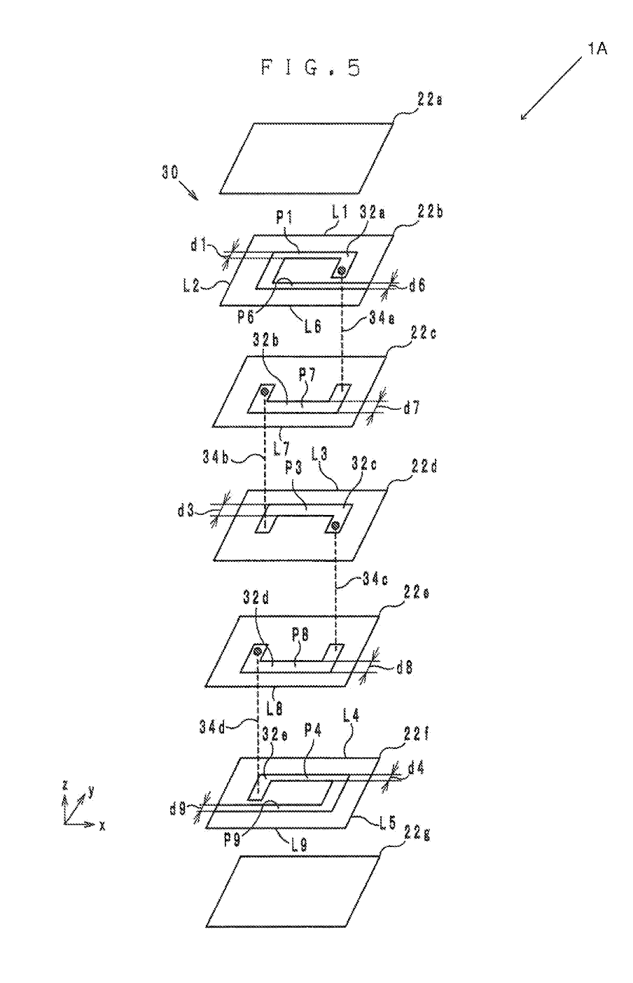

### First Modification; See FIG. 5

By a first modification of the method for manufacturing laminated coil components, laminated coil components 1A are produced. The difference between the laminated coil components 1 and the laminated coil components 1A is in the shapes of the linear conductors 32a and 32e. Specifically, as shown in FIG. 5, the linear conductors 32a and 32e of each of the laminated coil components 1A extend along the positive and negative sides in the x-axis direction and along the positive and negative sides in the y-axis direction.

The line width d1 of the part P1 of the linear conductor 32a extending along the edge L1 at the positive side in the y-axis direction of the insulating layer 22b is smaller than the line width d3 of the part P3 of the linear conductor 32c extending along the edge L3 at the positive side in the y-axis direction of the insulating layer 22d. The line width d6 of a part P6 of the linear conductor 32a extending along an edge L6 at the negative side in the y-axis direction of the insulating layer 22b is smaller than the line width d7 of a part P7 of the linear conductor 32b extending along an edge L7 at the negative side in the y-axis direction of the insulating layer 22c and the line width d8 of a part P8 of the linear conductor 32d extending along an edge L8 at the negative side in the y-axis direction of the insulating layer 22e.

The line width d4 of the part P4 of the linear conductor 32e extending along the edge L4 at the positive side in the y-axis direction of the insulating layer 22f is smaller than the line width d3 of the part P3 of the linear conductor 32c extending along the edge L3 at the positive side in the y-axis direction of the insulating layer 22d. The line width d9 of a part P9 of the linear conductor 32e extending along an edge L9 at the negative side in the y-axis direction of the insulating layer 22f is smaller than the line width d7 of the part P7 of the linear conductor 32b extending along the edge L7 at the negative side in the y-axis direction of the insulating layer 22c and the line width d8 of the part P8 of the linear conductor 32d extending along the edge L8 at the negative side in the y-axis direction of the insulating layer 22e.

In the laminated coil component 1A of the structure above, the linear conductors 32a and 32e are prevented from protruding from the linear conductors 32b through 32d in a direction perpendicular to the direction of lamination. Thus, the laminated coil component 1A produced by the manufacturing method according to the first modification is nearly unaffected by misalignment of linear conductors after lamination due to print displacement. There are no other differences in structure between the laminated coil component 1 and the laminated coil component 1A, and accordingly, the description above in connection with the laminated coil component 1 also applies to the elements of the laminated coil component 1A other than the linear conductors 32a and 32e.

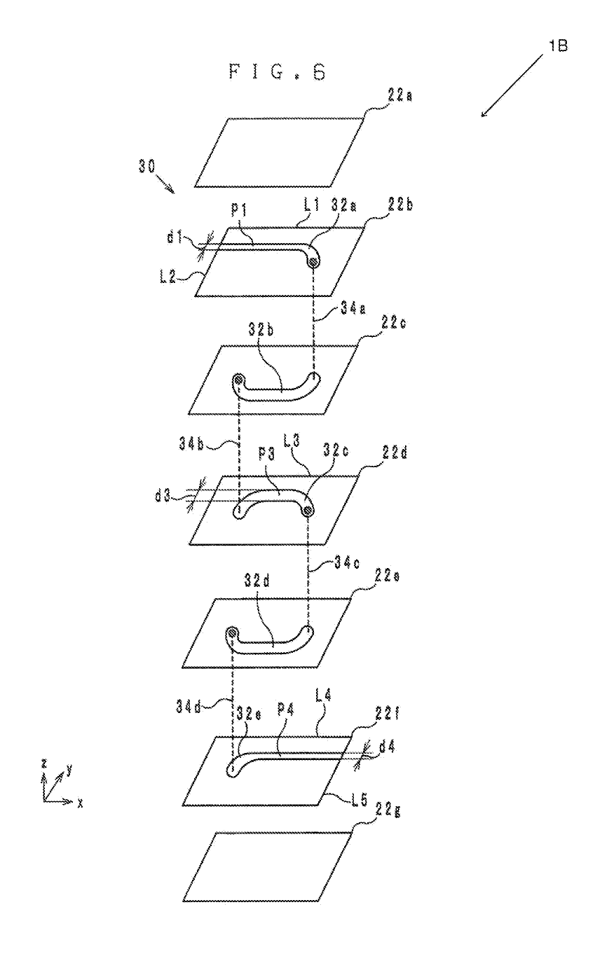

### Second Modification; See FIG. 6

By a second modification of the method for manufacturing laminated coil components, laminated coil components 1B are produced. The difference between the laminated coil components 1 and the laminated coil components 1B is in the shapes of the linear conductors 32a through 32e. Specifically, as shown in FIG. 6, the linear conductors 32a through 32e of each of the laminated coil components 1B have rounded corners.

The laminated coil component 1B of the structure above have the same advantageous effects as the laminated coil component 1. The laminated coil component 1B produced by the manufacturing method according to the second modification is nearly unaffected by misalignment of linear conductors after lamination due to print displacement. There are no other differences in structure between the laminated coil component 1 and the laminated coil component 1B, and accordingly, the description above in connection with the laminated coil component 1 also applies to the elements of the laminated coil component 1B other than the linear conductors 32a through 32e.

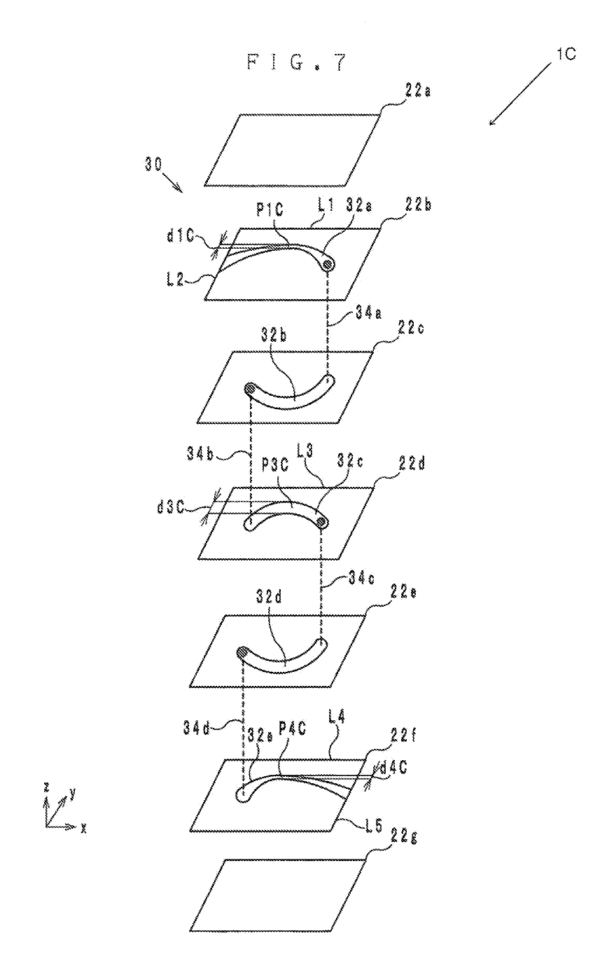

### Third Modification; See FIG. 7

By a third modification of the method for manufacturing laminated coil components, laminated coil components 1C are produced. The difference between the laminated coil components 1 and the laminated coil components 1C is in the shapes of the linear conductors 32a through 32e. Specifically, as shown in FIG. 7, in each of the laminated coil components 1C, the linear conductors 32a through 32e are formed into a semi-elliptical shape on the insulating layers 22b through 22f, respectively.

The line width d1C of a part P1C of the linear conductor 32a closest to the edge L1 at the positive side in the y-axis direction of the insulating layer 22b is smaller than the line width d3C of a part P3C of the linear conductor 32c overlapping with the part P1C when viewed from the z-axis direction. The line width d4C of a part P4C of the linear conductor 32e closest to the edge L4 at the positive side in the y-axis direction of the insulating layer 22f is smaller than the line width d3C of the part P3C of the linear conductor 32c overlapping with the part P4C when viewed from the z-axis direction.

The laminated coil component 1C of the structure above have the same advantageous effects as the laminated coil component 1. The laminated coil 1C produced by the manufacturing method according to the third modification is nearly unaffected by misalignment of linear conductors after lamination due to print displacement.

In the laminated coil component 1C, the line width d1C of the part P1C closest to the edge L1 and the line width d4C of the part P4C closest to the edge L4 are smaller. This is because narrowing these parts P1C and P4C is the most effective to prevent the cutting of the mother laminate with reference to the positions of the linear conductors 32c from causing the linear conductors 32a and 32e to be exposed on the surface of the laminated coil 1C.

There are no other differences in structure between the laminated coil component 1 and the laminated coil component 1C, and accordingly, the description above in connection with the laminated coil component 1 also applies to the elements of the laminated coil component 1C other than the linear conductors 32a through 32e.

### Other Embodiments

Methods for manufacturing laminated coil components according to the present disclosure are not limited to the embodiment described above. For example, only the line width d1 of the linear conductor 32a may be smaller than the line width d3 of the linear conductor 32c, while the line width d4 of the linear conductor 32e may be equal to the line width d3.

In the embodiment above, the linear conductors 32b and 32d are symmetrical with the linear conductor 32c about a point. However, the linear conductors 32b and 32d not necessarily have to be symmetrical with the linear conductor 32c about a point, and it is only necessary that the linear conductors 32b and 32d form a loop together with the conductor 32c when viewed from the z-axis direction.

In the laminated coil component 1 and the laminated coil component 1A, the line widths d1 and d6 of the parts of the linear conductor 32a extending along the edges L1 and L6 at the sides in the y-axis direction of the insulating layer 22b and the line widths d4 and d9 of the parts of the linear conductor 32e extending along the edges L4 and L9 at the sides in the y-axis direction of the insulating layer 22f are made smaller. In addition, the line widths of the parts of these conductors 32a and 32e extending along edges at the sides in the x-axis direction of the insulating layers 22b and 22f may be made smaller.

Although the present disclosure has been described in connection with the preferred embodiments above, it is to be noted that various changes and modifications are possible for a person skilled in the art. Such changes and modifications are to be understood as being within the scope of the present disclosure.

What is claimed is:

1. A method for manufacturing a laminated coil component by laminating green sheets, each having a plurality of printed linear conductors thereon, the method comprising:
forming a first green sheet including pairs of a first area and a second area having rectangular identical shapes and bordering each other, the first area having a first linear conductor printed thereon, the second area having a second linear conductor printed thereon;
forming a second green sheet including pairs of a third area and a fourth area, having identical shapes with the first area, and bordering each other, the third area having a third linear conductor printed thereon, the fourth area having a fourth linear conductor printed thereon;
placing the second green sheet on the first green sheet;
staggering another second green sheet on the second green sheet, in a direction perpendicular to a direction of lamination, by an amount corresponding to a side of the rectangular first area, wherein:
the third linear conductor and the fourth linear conductor form a loop when viewed from the direction of lamination;
an end of the first linear conductor is connected to a first side being an edge of the first area; and
a part of the first linear conductor closest to a second side adjacent to the first side has a line width smaller than a part of the third linear conductor overlapping with the part of the first linear conductor when viewed from the direction of lamination or smaller than a part of the fourth linear conductor overlapping with the part of the first linear conductor when viewed from the direction of lamination.

2. The method according to claim 1, wherein the first green sheet is placed after the step of staggering of another second green sheet on the second green sheet.

3. The method according to claim 1, wherein the staggering of another second green sheet on the second green sheet is in a direction parallel to the second side.
